(19) United States
(12) Patent Application Publication
(10) Pub. No.: US 2023/0213904 A1
(43) Pub. Date: Jul. 6, 2023

(54) TWO-CHANNEL RECEIVING

(71) Applicant: Julius Blum GmbH, Hoechst (AT)

(72) Inventors: Thomas RUEDISSER, Hohenems (AT); Florian BURTSCHER, Dornbirn (AT); Thomas TAIMLER, Hoechst (AT)

(21) Appl. No.: 18/073,182

(22) Filed: Dec. 1, 2022

Related U.S. Application Data
(63) Continuation of application No. PCT/AT2021/060191, filed on Jun. 2, 2021.

(30) Foreign Application Priority Data
Jun. 5, 2020 (AT) A 50492/2020

(51) Int. Cl. G05B 15/02

(52) U.S. Cl. CPC G05B 15/02

(57) ABSTRACT

A system includes a furniture element with which a part of an item of furniture is drivable or activatable, and a control device for actuating the a furniture element with a control command through an operating command. The control device includes a transmitting device, with which at least one digital control command is wirelessly transmissible to the furniture element, a first receiving device, with which at least one digital operating command transmitted according to a first transmission protocol is receivable, and a second receiving device, with which at least one digital operating command transmitted according to a second transmission protocol, which is different from the first transmission protocol, is receivable.

### BACKGROUND OF THE INVENTION

The present invention relates to a system consisting of at least one furniture element and at least one control device. The present invention further relates to a method for operating such a system. Furthermore, the present invention relates to a computer program product for performing such a method. The present invention also relates to a control device for such a system.

Systems consisting of at least one furniture element and at least one control device for driving or activating parts of items of furniture, and methods for operating such systems, are known in the state of the art. These systems, which can serve for instance to open drawers or furniture doors in a drive-assisted manner, usually follow a rigidly predefined sequence in a fixedly predefined system architecture. Construction, configuration and operation of known, often highly integrated and proprietary systems can only be effected with great effort. Operation, expansion or modification of the range of functions of such systems are often only possible by using a development environment and methodology predefined by the manufacturer. This creates rigid prerequisites for a co-operation of different operating elements and parts of the system.

The object of the invention is to specify a system, a method, a computer program product and a control device which do not have the disadvantages discussed above and in particular make a simplified construction, a simplified configuration and a simplified operation possible.

### SUMMARY OF THE INVENTION

The above object is achieved by a system consisting of at least one furniture element and at least one control device, a method for operating such a system, a computer program product for performing such a method, and a control device for such a system.

The system comprises at least one furniture element, which is preferably formed in the form of a furniture drive or a furniture lock. At least one part of an item of furniture can be drivable or activatable with the furniture element.

The furniture drive or the furniture lock can in particular be formed with an actuator or servomotor.

By a part of an item of furniture can be meant in particular a drawer, a furniture flap or a furniture door. In general, by a part of an item of furniture can be meant a part that is movable relative to a furniture carcass, or an activatable - for example lockable or unlockable - part.

With a furniture element formed as a furniture drive, at least one part of an item of furniture - thus for example a drawer that can be moved in and out, a pivotable furniture flap or a pivotable furniture door - can be drivable.

With a furniture element formed as a furniture lock, at least one part of an item of furniture - thus for example a lockable drawer, a blockable furniture flap or a blockable furniture door - can be activatable, thus for example can be released for access by a user or locked.

In the case of a furniture element formed as a furniture lock, for example a part of the furniture lock, such as for instance a rotating rod or a locking bolt, can be activatable and optionally also drivable. It is not to be ruled out that a furniture lock is provided by a furniture element formed as a furniture drive, in that an activatability of the furniture drive can be released or locked.

The system further comprises at least one control device for actuating the at least one furniture element. The at least one furniture element can be actuated by the at least one control device with a control command through an operating command.

At least one incoming operating command can for example be received by a control device of the system and, depending on the at least one operating command received, at least one outgoing control command for actuating at least one furniture element can for example be emitted by at least one control device.

The at least one control device has at least one transmitting device, with which at least one digital control command is wirelessly transmissible to the at least one furniture element. Through the transmitting device, a digital signal can be transmissible to the at least one furniture element via a wireless transmission path, wherein the digital signal can be a digitally encoded control command.

It is advantageous if the at least one furniture element has a suitable receiving device.

Through a wireless transmission of the at least one digital control command to the at least one furniture element, the system can be easily adapted to a varying number of control devices and/or furniture elements. A wireless transmission also simplifies the installation, configuration and maintenance of the system, as wired control lines need not be laid, allocated and kept in good condition.

A control command can generally be a digitally encoded data packet which is suitable for actuating the furniture element.

Furthermore, the at least one control device has at least one first receiving device, with which at least one digital operating command transmitted according to a first transmission protocol is receivable. Through the first receiving device, a digital signal can be receivable by the control device via a wireless or wired transmission path, wherein the digital signal can be an operating command digitally encoded according to a first transmission protocol.

Further, the at least one control device has at least one second receiving device, with which at least one digital operating command transmitted according to a second transmission protocol, which is different from the first transmission protocol, is receivable. Through the second receiving device, a digital signal can be receivable by the control device via a wireless or wired transmission path, wherein the digital signal can be an operating command digitally encoded according to a second transmission protocol.

The at least one control device can in principle serve as an interface for the networking of different input devices and different furniture elements.

An operating command can generally be a digitally encoded data packet, which is receivable by a receiving device of the control device.

An operating command can generally serve to operate or also configure the system or a part of the system.

The digital encoding and the wireless or wired transmission of the operating commands can be effected according to one or more transmission protocols, wherein it is not ruled out that the transmission protocols can correspond to known standards.

Because the control device has at least one first and one second receiving device, wherein the at least two receiving devices can receive operating commands transmitted according to different transmission protocols, an operation of the system with operating commands transmitted according to different transmission protocols can be made possible.

Through the presence of at least two receiving devices, which can receive operating commands transmitted according to different transmission protocols, a different transmission protocol can be utilized depending on the requirement for the operation of the system. The following requirements can be relevant for example for the use or the selection of a transmission protocol: range, data rate, security, energy requirement, infrastructure, redundancy, latency or availability.

It is not to be ruled out that the at least one control device has at least one transmitting device, which is formed for the transmission of an operating command according to the first and/or second transmission protocol. For example, an operating command received by a control device of the system can thereby be forwarded to at least one further control device of the system.

In an advantageous embodiment of the requirement, the at least one transmitting device, with which the at least one digital control command is wirelessly transmissible to the at least one furniture element, transmits the at least one digital control command according to a third transmission protocol, which is different from the first and second transmission protocols.

A further adaptation to requirements for the operation of the system can thereby be effected. Thus, for example for the transmission of the at least one digital control command, a third transmission protocol can be selected which has a particularly low energy requirement and a particularly low latency, but may have a reduced data rate compared with the first and the second transmission protocol.

Through a transmission of the at least one digital control command according to a third transmission protocol, which is different from the first and second transmission protocols, a transmission of the control command - and thus an actuation of at least one furniture element - can be done independently of the selection of the transmission protocol for receiving the operating command.

In an advantageous embodiment of the system, the first transmission protocol can be a radio transmission protocol according to the IEEE 802.11 standard and/or a wired transmission protocol according to the Ethernet standard. The standard denoted IEEE 802.11 is a known family of standards for Wireless Local Area Networks (WLAN). The standard denoted Ethernet is a known technology for wired data networks. A first transmission protocol chosen in such a way can make high data rates and a broad compatibility of the control device for devices by which operating commands can be received with the first receiving device of the control device possible.

In an advantageous embodiment of the system, the second transmission protocol can be a radio transmission protocol according to the Bluetooth standard. The standard denoted Bluetooth is an industry standard for data transmission between devices over short distances by radio technology. A second transmission protocol chosen in such a way can make a low energy consumption and a widespread compatibility of the control device for devices by which operating commands can be received with the second receiving device of the control device possible.

In an advantageous embodiment of the system, the digital control command can be transmissible according to a third transmission protocol, which is different from the first and second transmission protocols. The third transmission protocol can be a radio transmission protocol according to a ShockBurst™ or Enhanced ShockBurst™ standard. ShockBurst™ or Enhanced ShockBurst™ are known radio transmission protocols and are designed for operation in the worldwide ISM frequency band at 2.4 GHz. A third transmission protocol chosen in such a way can make a minimal energy consumption and minimal latencies for the actuation of at least one furniture element possible.

The digital operating command can be generatable by a user via a user interface, wherein the user interface can be formed by:
a touchscreen of an input device, and/or
a voice input into a speech-recognition device, and/or
an operating element (buttons, foot switch) of an input device operable by a user by hand or foot, and/or
gesture control of an input device for example realized with sensors, such as infrared or ultrasonic sensors, or a camera that can be performed by a user.

In principle, the system can have one or more input devices.

An input device can in principle be a device operable by a user, such as for instance a computer, a tablet or a smartphone. A formation of an input device similar to a remote control - for example in the form of a radio switch - or an operating panel is not to be ruled out.

An input device can have a transmitting device, with which at least one operating command is transmissible according to the first and/or second transmission protocol.

A user can generate at least one operating command via an optionally menu-driven user interface, for example by selecting a menu item and confirming it through an interaction with the input device.

In an advantageous embodiment, the system can comprise at least one speech-recognition device for generating a digital operating command, wherein the speech-recognition device can comprise:
at least one microphone for detecting a voice command of a user,
at least one conversion device for generating a digital operating command from the voice command,
at least one transmitting device for transmitting a digital operating command to the control device.

The individual constituents of the speech-recognition device can be distributed across different devices and services. Thus, in one embodiment, there can be a microphone in an input device, for example a smartphone, there can be a conversion device for generating a digital operating command from the voice command through a computerized service, optionally decentralized in a cloud service, and there can be a transmitting device for transmitting a digital operating command to the control device again in an input device, for instance a smartphone again.

In an advantageous embodiment, the system can have at least one internet-compatible communication device for connecting the system, in particular the control device, to the internet. Data, operating commands and/or information for generating operating commands can thereby be received from the internet by the system, in particular the control device. Data can also be transmitted to internet-based services and/or to devices with internet connection by an internet-compatible transmitting device of the system.

In an advantageous embodiment of the system, the control device and the furniture element can be formed structurally separate from each other and can be arrangeable or arranged spatially separate from each other. In such an embodiment, a control device and a furniture element can be installed independently of each other.

In an advantageous embodiment of the system, the control device can have at least one user operating mode and one configuration operating mode.

In the user operating mode a digital operating command for actuating at least one furniture element can be receivable by the first and/or second receiving device of the at least one control device. The user operating mode can correspond to a normal use of the system, for example the day-to-day use of an item of furniture of the system after configuration of the system has been effected.

In the configuration operating mode a digital operating command for configuring the control device can be receivable by the first and/or second receiving device of the at least one control device. As already mentioned, an operating command can serve to configure the system or a part of the system. Through such an operating command, the furniture elements that the system comprises and how these are to be actuated through control commands can be stored for example in a memory of the control device. Through the provision of such a configuration operating mode, an initial configuration and also a further adaptation of the system carried out at a later point in time can be effected in a simple manner.

In the configuration operating mode, for example addresses of the receiving device of the furniture elements, function allocations of the furniture elements with respect to their formation as a furniture drive or furniture lock, allocation of the furniture elements to drivable or activatable parts of at least one item of furniture of the system, information about the configuration of the transmission protocols, or general network architecture of the system can be stored in a memory in the control device through a digital operating command.

Protection is also sought for a method for operating a system as described previously. The method comprises at least the following method steps.

The at least one control device receives at least one digital operating command transmitted according to a first transmission protocol by the at least one first receiving device in a receiving method step.

Alternatively or in combination, the at least one control device receives at least one digital operating command transmitted according to a second transmission protocol by the at least one second receiving device in a receiving method step.

The at least one control device wirelessly transmits at least one digital control command to a receiving device of the at least one furniture element by the at least one transmitting device in a transmitting method step.

Advantages of such a method are a flexible reception of a digital control command according to a first and/or second transmission protocol by at least one receiving device of the control device and a wireless transmission of a digital control command to a furniture element. An operation of a system as described previously can thereby be able to be easily set up, implemented and adapted.

It is not to be ruled out that in a first forwarding method step, at least one control device of the system forwards an operating command received in a receiving method step to a further control device of the system according to the first and/or second transmission protocol.

It can be advantageous if at least one furniture element wirelessly forwards at least one digital control command received beforehand to a receiving device of a further furniture element of a system by means of at least one transmitting device allocated to the furniture element in a second forwarding method step.

In an advantageous embodiment of the method, the digital operating command received in the receiving method step and the digital control command transmitted in the transmitting method step can be received and transmitted according to different transmission protocols. An adaptation of the reception and transmission to different requirements with respect to range, data rate, security, energy requirement, infrastructure, redundancy, latency or availability can thereby be made possible.

In an advantageous embodiment of the method:
a reception can be effected according to the first transmission protocol according to the IEEE 802.11 standard and/or according to the Ethernet standard in the receiving method step, and/or
a reception can be effected according to the second transmission protocol according to the Bluetooth standard in the receiving method step, and/or
a transmission can be effected according to a third transmission protocol, which is different from the first and second transmission protocols, according to the ShockBurst™ or according to the Enhanced ShockBurst™ standard in the transmitting method step.

In an advantageous embodiment of the method, in the transmitting method step a transmission of the at least one digital control command to a receiving device of the at least one furniture element can be effected using at least one of the following measures:
A transmission can be effected unidirectionally between the control device and the receiving device of the at least one furniture element. A bidirectional communication is not to be ruled out, but a bidirectional communication being effected can contribute to reduced latencies and to a reduced extent to the energy requirement.
A transmission can be effected addressed directly to the receiving device of the at least one furniture element. As a result, a “pairing” being effected before each transmission can be dispensed with, which can have a positive effect on the latencies. The address of the receiving device of a furniture element can have been stored for example in a memory of the control device in a configuration operating mode.
A transmission can be effected by a transmitting device of the furniture element without a confirmation of receipt. It can thereby be avoided for example that the furniture element has to be toggled between an operating mode in which the furniture element is in a ready-to-receive state and an operating mode in which the furniture element is in a ready-to-transmit state. A transmission can preferably be effected without an unsolicited confirmation of receipt. In principle, a transmission can be effected without a confirmation of receipt, wherein there is still the option of requesting a confirmation of receipt (for example depending on the composition of a control command).
A transmission can be effected without checking the readiness to receive of the receiving device of the at least one furniture element. It can be advantageous that the receiving device of the at least one furniture element is in principle in a ready-to-receive state and during operation does not have to be able to be transferred to a ready-to-receive state first. It is not to be ruled out that the furniture element can be able to be transferred to a ready-to-transmit state through a corresponding control command.
A transmission can be effected with a fixedly predefined or predefinable routing of the at least one digital control command. Thus, for example, a control command forwarded in a further, second transmitting method step can follow a fixedly predefined or fixedly predefinable routing between furniture elements of the system.

In an advantageous embodiment of the method, in a first generating method step a generation of the at least one digital operating command can be effected by a user via a user interface. A generation can be effected through an interaction with the user interface by the user via:
a “touchscreen” of an input device, and/or
a voice input into a speech-recognition device, and/or
an operating element of an input device operable by the user by hand or foot, and/or
gesture control of an input device that can be performed by a user.

In an advantageous embodiment of the method, depending on an operating command received in the receiving method step:
different digital control commands can be generated in a second generating method step, and/or
different digital control commands can be transmitted in the transmitting method step.

It can be made possible for different furniture elements to be actuated and/or for furniture elements to be actuated differently depending on an operating command, for example generated by a user. An actuation can differ with respect to speed, distance, permissibility or how it is performed.

In an advantageous embodiment of the method, in an activating method step, an activation of the furniture element can be effected through at least one digital control command received. An activation can comprise in particular a drive or an activation of at least one part of an item of furniture by the furniture element.

An activation of the at least one furniture element with the control command wirelessly received by the receiving device of the at least one furniture element can be effected by the control device within a period of less than 100 ms, preferably less than 50 ms, from the transmission of the digital control command.

In an advantageous embodiment of the method, the at least one control device can have at least one user operating mode and one configuration operating mode.

In the user operating mode, a reception of a digital operating command by the receiving device of the at least one control device for actuating at least one furniture element can be effected. In the configuration operating mode a reception of a digital operating command by the receiving device of the at least one control device for configuring the control device can be effected.

As already mentioned, an operating command can serve to configure the system or a part of the system. Through such an operating command, in a configuring method step the furniture elements that the system comprises and how these are to be actuated through control commands can be stored for example in a memory of the control device. Through the provision of such a configuration operating mode, an initial configuration and also a further adaptation of the system carried out at a later point in time can be effected in a simple manner.

In the configuration operating mode, in a configuring method step for example addresses of the receiving device of the furniture elements, function allocations of the furniture elements with respect to their formation as a furniture drive or furniture lock, allocation of the furniture elements to drivable or activatable parts of at least one item of furniture of the system, information about the configuration of the transmission protocols, or general network architecture of the system can be stored in a memory in the control device through a digital operating command.

Digital operating commands for configuring the system can be generated, transmitted and received analogously to operating commands for operating the system.

Protection is also sought for a computer program product, comprising commands from a memory unit which is in or can be brought into data connection with the processing unit that, when executed by a processing unit, cause the latter to perform a method as described previously.

The computer program product can be stored for example in at least one memory unit of a control device and can be executed by the at least one processing unit of a control device.

Protection is also sought for a control device for a system as described previously.

Such a control device can advantageously have at least one processing unit at least one memory unit that is in or can be brought into data connection with it.

### BRIEF DESCRIPTION OF THE DRAWINGS

Embodiment examples of the invention are discussed with reference to the figures. There are shown in:

FIG. 1 is a schematic representation of an embodiment of a system,

FIG. 2 is a schematic representation of an embodiment of an input device,

FIG. 3 is a schematic representation of a further embodiment of a system,

FIGS. 4a and 4b are perspective views of embodiments of items of furniture,

FIG. 5 is a perspective view of a further embodiment of an item of furniture,

FIG. 6 is a perspective view of a further embodiment of an item of furniture,

FIG. 7 is a schematic sequence of an embodiment of a method, and

FIG. 8 is a schematic sequence of a further embodiment of a method.

### DETAILED DESCRIPTION OF THE INVENTION

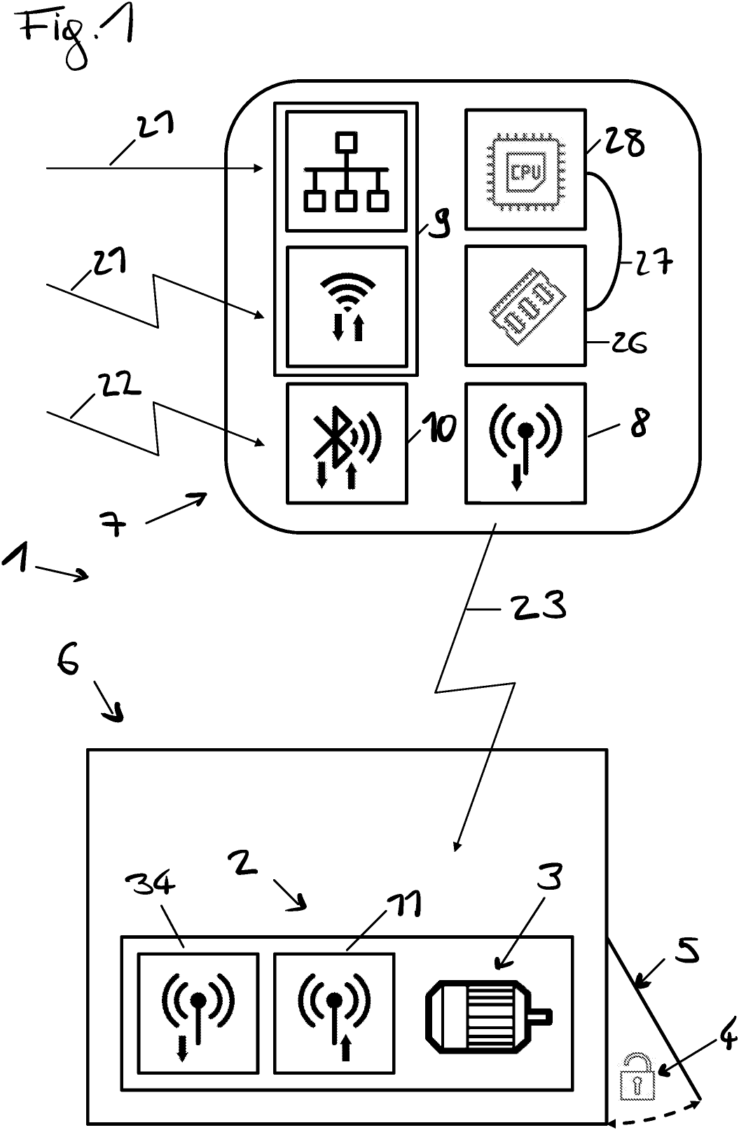

FIG. 1 shows an embodiment of a system 1 consisting of a furniture element 2, for instance a furniture drive 3 or a furniture lock 4, with which at least one part 5 of an item of furniture 6 is drivable or activatable, and a control device 7 for actuating the at least one furniture element 2 with a control command through an operating command. The control device 7 has at least one transmitting device 8, with which at least one digital control command is wirelessly transmissible to a receiving device 11 allocated to the furniture element 2. A digital operating command transmitted according to a first transmission protocol 21 is receivable with a first receiving device 9, and a digital operating command transmitted according to a second transmission protocol 22, which is different from the first transmission protocol 21, is receivable with a second receiving device 10.

At least one digital operating command can be transmitted with the transmitting device 8, with which the at least one digital control command is wirelessly transmissible to the at least one furniture element 2, according to a third transmission protocol 23, which is different from the first 21 and second 22 transmission protocols.

The first transmission protocol 21 can advantageously be a radio transmission protocol according to the IEEE 802.11 standard and/or a wired transmission protocol according to the Ethernet standard. In the embodiment of the first receiving device 9 shown in FIG. 1, it is formed for data transmission according to the IEEE 802.11 standard and according to the Ethernet standard. However, unlike what is represented, it is also conceivable to provide corresponding receiving devices formed separate from each other.

The second transmission protocol 22 can advantageously be a radio transmission protocol according to the Bluetooth standard.

Advantageously, the digital control command can be transmissible according to a third transmission protocol 23, which is different from the first and second transmission protocols 21, 22, wherein the third transmission protocol 23 can be a radio transmission protocol according to a ShockBurst™ or Enhanced ShockBurst™ standard.

Optionally, the furniture element 2 can have a transmitting device 34. It is conceivable that a digital control command is transmissible with the optional transmitting device 34 according to the third transmission protocol 23.

In the embodiment shown, the control device 7 has a processing unit 25 and a memory unit 26 that is in or can be brought into data connection 27 with it. In such an embodiment, the control device 7 can be suitable to a computer program product, comprising commands from the memory unit 26 which, when executed by the processing unit 25, cause the latter to perform a method as described below.

The control device 7 can have at least one user operating mode and one configuration operating mode, wherein
in the user operating mode a digital operating command for actuating at least one furniture element 2 is receivable by the first 9 and/or second 10 receiving device of the at least one control device 7 and/or
in the configuration operating mode a digital operating command for configuring the control device 7 is receivable by the first 9 and/or second 10 receiving device of the at least one control device 7.

In the configuration operating mode for example addresses of the receiving device 11 of the furniture elements 2, function allocations of the furniture elements 2 with respect to their formation as a furniture drive 3 or furniture lock 4, allocation of the furniture elements 2 to drivable or activatable parts 5 of at least one item of furniture 6 of the system 1, information about the configuration of the transmission protocols 21, 22, 23, or general network architecture of the system 1 can be stored in a memory unit in the control device 7 through a digital operating command.

In the embodiment shown, the control device 7 and the furniture element 2 of the system 1 are formed structurally separate from each other and are arrangeable or arranged spatially separate from each other.

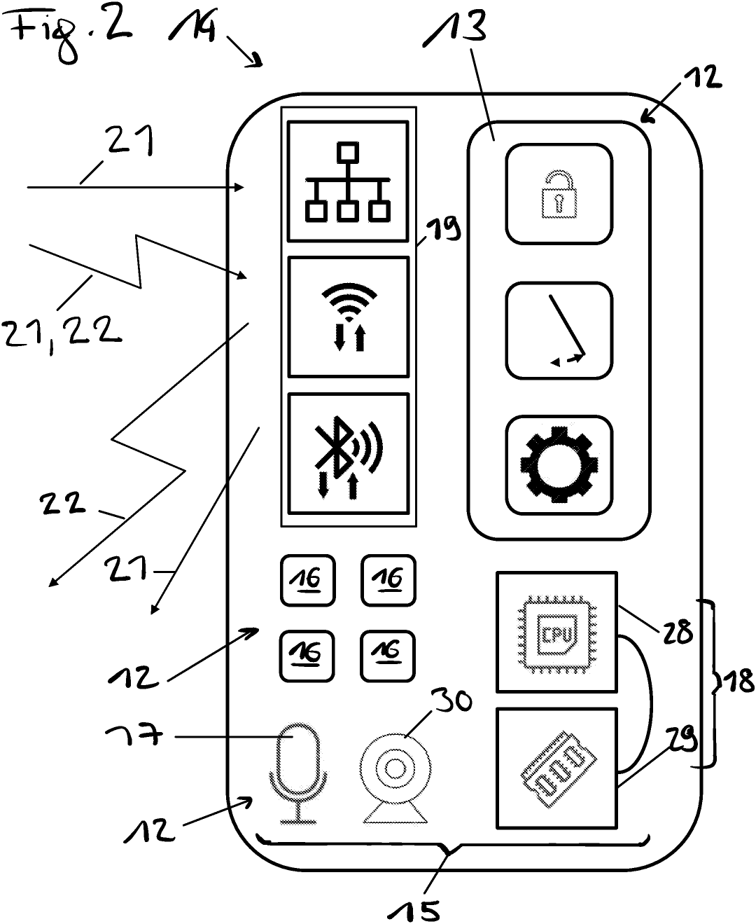

FIG. 2 shows a particularly advantageous embodiment of an input device 14, wherein this input device has different embodiments of user interfaces 12.

As represented, the user interface 12 can be formed by
a touchscreen 13 of the input device 14 and/or
a voice input into a speech-recognition device 15 and/or
an operating element 16 of the input device 14 operable by a user by hand or foot and/or
gesture control of the input device 14 that can be performed by a user, here for example with the aid of the camera 30.

For example, operating commands can be generated and transmitted by the input device 14. Through the operating commands, an actuation of a furniture element 2, a configuration of the system 1 and in particular of the control device 7, and a change into different operating modes of the control device 7 and the furniture elements 2 can be effected.

Unlike what is represented, the individual user interfaces 12 can be split onto different input devices 14 formed separate from each other.

In the embodiment shown, the input device 14 has a combined transmitting and receiving device 19, by means of which a data transmission according to the transmission protocols 21, 22 is possible. Unlike what is represented, the input device 14 can also have separate, fewer or more, devices for data transmission.

The speech-recognition device 15 for generating a digital operating command comprises, in the embodiment shown,
at least one microphone 17 for detecting a voice command of a user
at least one conversion device 18 for generating a digital operating command from the voice command, wherein the conversion device 18 here is formed with commands from a memory unit 29 that can be executed by the processing unit 28
at least one transmitting device, in this embodiment formed by way of example as a transmitting and receiving device 19 of the input device 14, for transmitting a digital operating command to the control device 7.

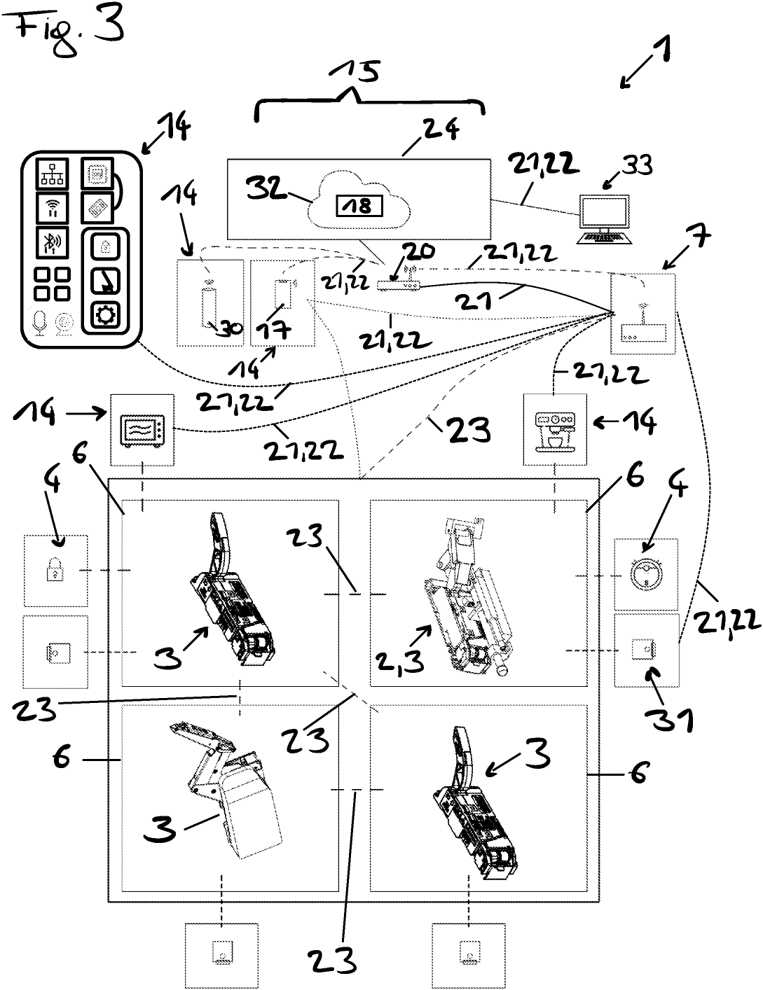

Unlike what is represented in the embodiment of FIG. 2, for speech-recognition device 15, there can be a microphone 17 in an input device 14, for example a smartphone, and there can be a conversion device 15 for generating a digital operating command from the voice command through a computerized service, optionally decentralized in a cloud service (see FIG. 3), and there can be a transmitting device for transmitting a digital operating command to the control device 7 again in an input device 14, for instance a smartphone again.

A gesture control of an input device 14 that can be performed by a user can be provided analogously with the aid of a sensor, in the embodiment shown for instance with the camera 30, and with commands from a memory unit 29 that can be executed by the processing unit 28.

A particularly preferred embodiment of a system 1 is shown in FIG. 3.

The system first of all has different furniture elements 2, which are formed as furniture drives 3 for different furniture flaps and furniture doors, and as a furniture lock 4. The system further has a control device 7 for actuating the furniture elements 2, wherein the control device 7 can in principle be formed according to the embodiment shown in FIG. 1.

In the embodiment shown, the system 1 has different input devices 14, with which in each case at least one digital operating command encoded according to a first transmission protocol 21 and/or according to a second transmission protocol 22, which is different from the first transmission protocol 21, is transmissible to the control device. It can correspondingly be provided that the at least one control device 7 comprises at least one first receiving device 9, with which at least one digital operating command transmitted according to a first transmission protocol 21 is receivable, and at least one second receiving device 10, with which at least one digital operating command transmitted according to a second transmission protocol 22, which is different from the first transmission protocol 21, is receivable.

The different input devices 14 can be formed for example in the form of the embodiment shown in FIG. 2 of an input device 14, in the form of operating elements of a kitchen appliance, such as a microwave or a coffee machine, or in the form of a computer 33, a radio switch 31, or in the form of smart devices, such as for instance so-called intelligent personal assistants. Such input devices 14 can in principle have functionalities such as those of the embodiment shown in FIG. 2.

In the embodiment shown, the system 1 has at least one internet-compatible communication device 20 for connecting the system 1, in particular the control device 7, to the internet 24. A data transmission can be effected according to a first transmission protocol 21 and/or according to a second transmission protocol 22, which is different from the first transmission protocol 21.

In addition to an embodiment as described previously of a speech-recognition device 15, the system 1 can alternatively or additionally have a further embodiment of a speech-recognition device 15 for generating a digital operating command which, in the embodiment shown in FIG. 3, comprises at least the following components or assemblies:
at least one microphone 17 for detecting a voice command of a user
at least one conversion device 18 for generating a digital operating command from the voice command, wherein the conversion device 18 can be implemented through a computerized service, as represented here for example decentralized in a cloud service 32 on the internet 24
at least one transmitting device for transmitting a digital operating command to the control device 7.

It is conceivable that a digital control command transmitted according to the third transmission protocol 23 and received by a receiving device 11 of a furniture element 2 is forwardable to at least one further furniture element 2 by means of a transmitting device 34 of the furniture element 2. Analogously, this is conceivable for a forwarding of digital control commands between at least 2 control devices 7.

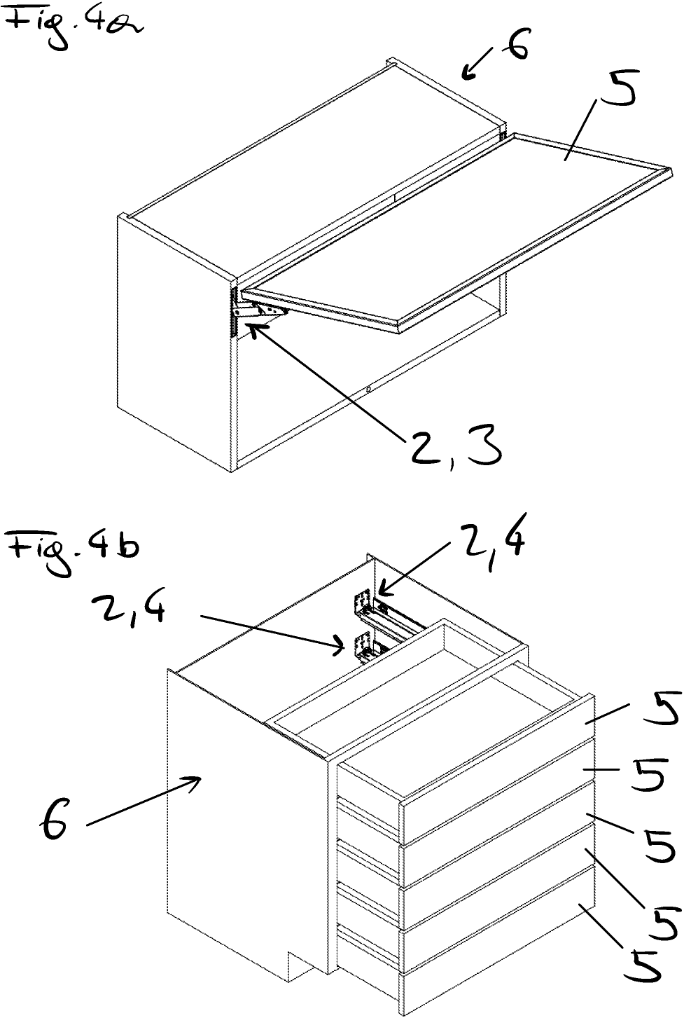

FIG. 4a shows an embodiment of an item of furniture 6 as a wall unit with a part 5, drivable by a furniture element 3 formed as a furniture drive 3, in the form of a swing-up flap.

FIG. 4b shows an embodiment of an item of furniture 6 as a chest of drawers with a part 5, lockable by a furniture element 3 formed as a furniture lock 4, in the form of individual drawers.

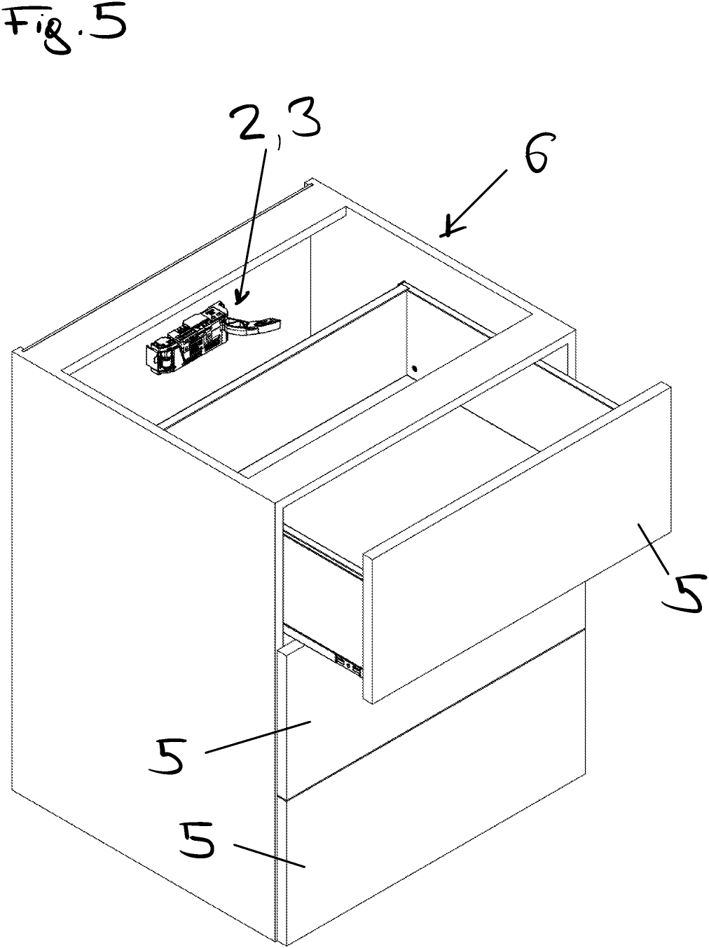

FIG. 5 shows an embodiment of an item of furniture 6 as a chest of drawers with a part 5, drivable by a furniture element 3 formed as a furniture drive 3, in the form of individual drawers.

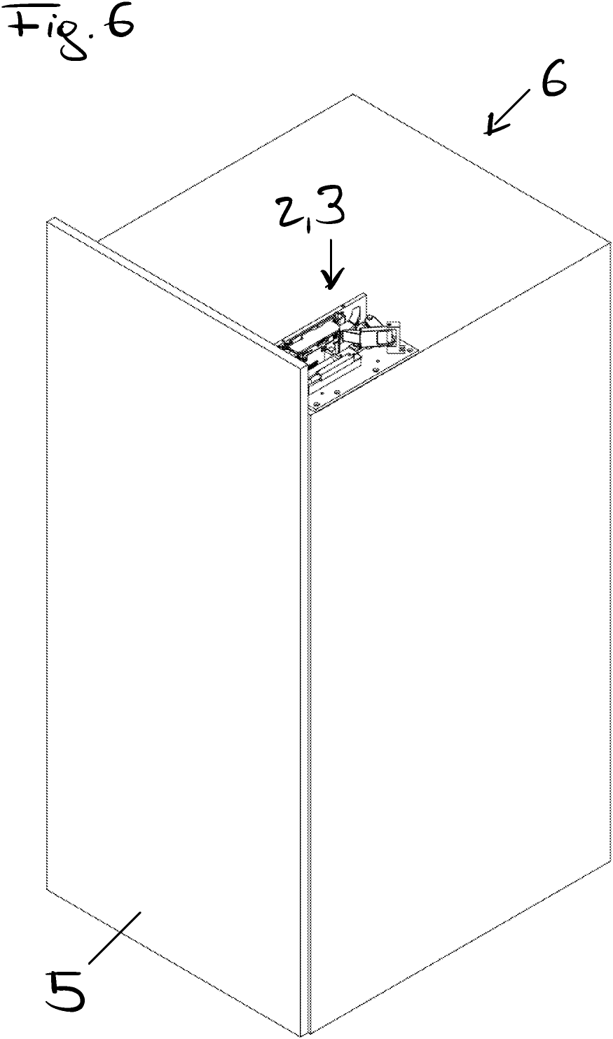

FIG. 6 shows an embodiment of an item of furniture 6 as a refrigerator with a part 5, drivable by a furniture element 3 formed as a furniture drive 3, in the form of a furniture door.

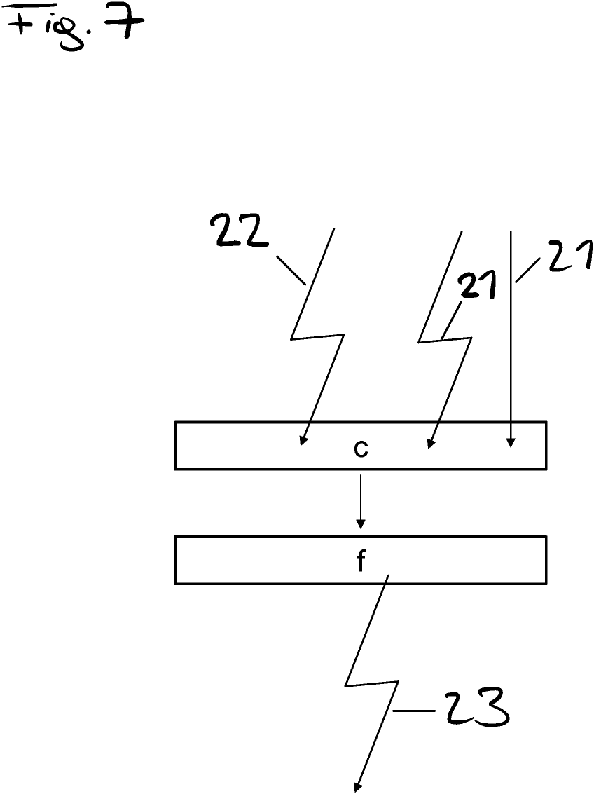

The sequence of an embodiment of a method for operating a system 1 as described previously is represented in a block diagram in FIG. 7, wherein reference numbers are used to refer to the previously described parts of the embodiments of the system 1. For the operation of the system 1, it is not necessary always to perform all of the listed method steps.

In the embodiment shown, the method comprises the following method steps:
the at least one control device 7 receives at least one digital operating command transmitted according to a first transmission protocol 21 by means of the at least one first receiving device 9 in a receiving method step c, and/or
the at least one control device 7 receives at least one digital operating command transmitted according to a second transmission protocol 22 by means of the at least one second receiving device 10 in a receiving method step c, and
the at least one control device 7 wirelessly transmits at least one digital control command to a receiving device 11 of the at least one furniture element 2 by means of the at least one transmitting device in a transmitting method step f.

The digital operating command received in the receiving method step c and the digital control command transmitted in the transmitting method step f can be received and transmitted according to different transmission protocols 21, 22, 23.

It is possible for:
a reception to be effected according to the first transmission protocol 21 according to the IEEE 802.11 standard and/or according to the Ethernet standard in the receiving method step c, and/or
a reception to be effected according to the second transmission protocol 22 according to the Bluetooth standard in the receiving method step c, and/or
a transmission to be effected according to a third transmission protocol 23, which is different from the first 21 and second 22 transmission protocols, according to the ShockBurst™ or according to the Enhanced ShockBurst™ standard in the transmitting method step f.

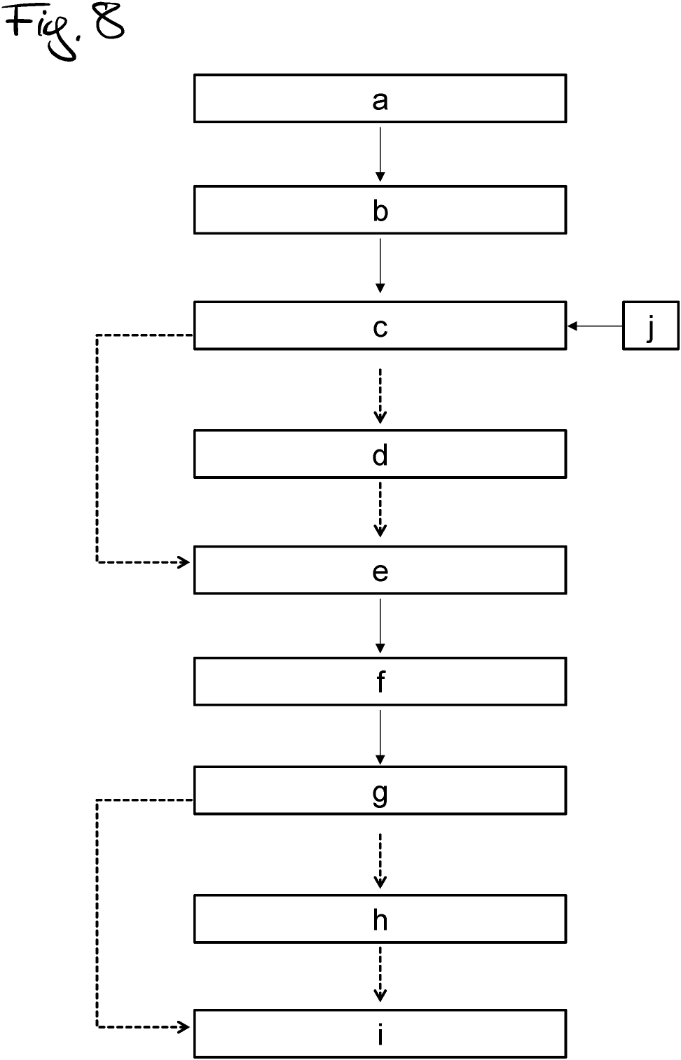

The sequence of a particularly preferred embodiment of a method for operating an embodiment of a system 1 as described previously is represented in a block diagram in FIG. 8, wherein reference numbers are again used to refer to the previously described parts of the embodiments of the system 1.

In the embodiment shown, the method comprises at least the following method steps:
a first generating method step a
an operating command transmitting method step b
a receiving method step c
an optional first forwarding method step d
a second generating method step e
a transmitting method step f
a second receiving method step g
an optional second forwarding method step h
an activating method step i
a configuring method step j

A generation of the at least one digital operating command can be effected by a user via a user interface 12 in a first generating method step a, wherein a generation can be effected through an interaction with the user interface 12 by the user via:
a touchscreen of an input device 14, and/or
a voice input into a speech-recognition device, and/or
an operating element of an input device 14 operable by the user by hand or foot, and/or
gesture control of an input device 14 that can be performed by a user.

A transmission of at least one digital operating command to at least one control device 7 can be effected in an operating command transmitting method step b.

The reception of at least one digital operating command can be effected analogously to the embodiment of the method in FIG. 7 in a receiving method step c.

In a user operating mode of the control device 7 a reception of a digital operating command by the receiving device 9, 10 of at least one control device 7 for actuating at least one furniture element 2 is effected.

In a configuration operating mode of the control device 7 a reception of a digital operating command by the receiving device 9, 10 of the at least one control device 7 for configuring the control device 7 is effected, wherein a configuration can be effected in a corresponding configuring method step j.

Optionally, for example to increase the range, an operating command received in the receiving method step c can be forwarded to at least one further control device 7 in a forwarding method step d.

In a second generating method step e at least one control command can be generated with the at least one operating command received in the receiving method step c.

In the second generating method step e, depending on the operating command received in the receiving method step c:
different digital control commands can be generated in the generating method step e, and/or
different digital control commands can be transmitted in the transmitting method step f.

The transmission of at least one digital control command can be effected analogously to the embodiment of the method in FIG. 7 in a transmitting method step f.

In a second receiving method step g a reception of the at least one digital control command can be effected by a receiving device 11 of at least one furniture element 2.

Optionally, for example to increase the range, a control command received in the receiving method step c can be forwarded to at least one further furniture element 2 in a second forwarding method step h.

In an activating method step i an activation of the furniture element 2, in particular a drive or an activation of at least one part 5 of an item of furniture 6 by the furniture element 2, can be effected through the at least one digital control command received.

List of reference numbers

| | |
|---|---|
| 1 | system |
| 2 | furniture element |
| 3 | furniture drive |
| 4 | furniture lock |
| 5 | part |
| 6 | item of furniture |
| 7 | control device |
| 8 | control device transmitting device |
| 9 | first receiving device |
| 10 | second receiving device |
| 11 | furniture element receiving device |
| 12 | user interface |
| 13 | touchscreen |
| 14 | input device |
| 15 | speech-recognition device |
| 16 | operating element |
| 17 | microphone |
| 18 | conversion device |
| 19 | input device transmitting and receiving device |
| 20 | communication device |
| 21 | first transmission protocol |
| 22 | second transmission protocol |
| 23 | third transmission protocol |
| 24 | internet |
| 25 | processing unit |
| 26 | memory unit |
| 27 | data connection |
| 28 | processing unit |
| 29 | memory unit |
| 30 | camera |
| 31 | radio switch |
| 32 | cloud service |
| 33 | personal computer |
| 34 | furniture element transmitting device |
| a | first generating method step |
| b | operating command transmitting method step |
| c | receiving method step |
| d | first forwarding method step |
| e | second generating method step |
| f | transmitting method step |
| g | second receiving method step |
| h | second forwarding method step |
| i | activating method step |
| j | configuring method step |

1. A system comprising a furniture element, preferably a furniture drive or a furniture lock, with which at least one part of an item of furniture is drivable or activatable, and a control device for actuating the at least one furniture element with a control command through an operating command, wherein the at least one control device comprises at least one transmitting device, with which at least one digital control command is wirelessly transmissible to the at least one furniture element, at least one first receiving device, with which at least one digital operating command transmitted according to a first transmission protocol is receivable, and at least one second receiving device, with which at least one digital operating command transmitted according to a second transmission protocol, which is different from the first transmission protocol, is receivable.

2. The system according to claim 1, wherein the at least one transmitting device, with which the at least one digital control command is wirelessly transmissible to the at least one furniture element, transmits the at least one digital operating command according to a third transmission protocol, which is different from the first and second transmission protocols.

3. The system according to claim 1, wherein:
the first transmission protocol is a radio transmission protocol according to the IEEE 802.11 standard and/or a wired transmission protocol according to the Ethernet standard, and/or
the second transmission protocol is a radio transmission protocol according to the Bluetooth standard, and/or
the digital control command is transmissible according to a third transmission protocol, which is different from the first and second transmission protocols, wherein the third transmission protocol is a radio transmission protocol according to a ShockBurst™ or Enhanced ShockBurst™ standard.

4. The system according to claim 1, wherein the digital operating command is generatable by a user via at least one user interface, wherein the user interface is formed by:
a touchscreen of an input device, and/or
a voice input into a speech-recognition device, and/or
an operating element of an input device operable by a user by hand or foot, and/or
gesture control of an input device that can be performed by a user.

5. The system according to claim 1, wherein the system comprises at least one speech-recognition device for generating a digital operating command, wherein the speech-recognition device comprises:
at least one microphone for detecting a voice command of a user,
at least one conversion device for generating a digital operating command from the voice command,
at least one transmitting device for transmitting a digital operating command to the control device.

6. The system according to claim 1, wherein the system has at least one internet-compatible communication device for connecting the system, in particular the control device, to the internet.

7. The system according to claim 1, wherein the control device and the furniture element are formed structurally separate from each other and are arrangeable or arranged spatially separate from each other.

8. The system according to claim 1, wherein the control device has at least one user operating mode and one configuration operating mode, wherein:
in the user operating mode a digital operating command for actuating at least one furniture element is receivable by the first and/or second receiving device of the at least one control device, and/or
in the configuration operating mode a digital operating command for configuring the control device is receivable by the first and/or second receiving device of the at least one control device.

9. A method for operating the system according to claim 1, comprising:
the at least one control device receives, in a receiving method step, at least one digital operating command transmitted according to a first transmission protocol by means of the at least one first receiving device, and/or
the at least one control device receives, in a receiving method step, at least one digital operating command transmitted according to a second transmission protocol by the at least one second receiving device, and
the at least one control device wirelessly transmits, in a transmitting method step, at least one digital control command to a receiving device of the at least one furniture element by the at least one transmitting device.

10. The method according to claim 9, wherein the digital operating command received in the receiving method step and the digital control command transmitted in the transmitting method step are received and transmitted according to different transmission protocols.

11. The method according to claim 9, wherein:
a reception is effected according to the first transmission protocol according to the IEEE 802.11 standard and/or according to the Ethernet standard in the receiving method step, and/or
a reception is effected according to the second transmission protocol according to the Bluetooth standard in the receiving method step, and/or
a transmission is effected according to a third transmission protocol, which is different from the first and second transmission protocols, according to the ShockBurst™ or according to the Enhanced ShockBurst™ standard in the transmitting method step.

12. The method according to claim 9, wherein in the transmitting method step a transmission of the at least one digital control command to a receiving device of the at least one furniture element:
is effected unidirectionally between the control device and the receiving device of the at least one furniture element, and/or
is addressed directly to the receiving device of the at least one furniture element, and/or
is effected by a transmitting device of the furniture element without a confirmation of receipt, preferably without an unsolicited confirmation of receipt, and/or
is effected without checking the readiness to receive of the receiving device of the at least one furniture element, and/or
is effected with a fixedly predefined or predefinable routing of the at least one digital control command.

13. The method according to claim 9, wherein in a first generating method step a generation of the at least one digital operating command is effected by a user via a user interface, wherein a generation is effected through an interaction with the user interface by the user via:
a touchscreen of an input device, and/or
a voice input into a speech-recognition device, and/or
an operating element of an input device operable by the user by hand or foot, and/or
gesture control of an input device that can be performed by a user.

14. The method according to claim 9, wherein, depending on an operating command received in the receiving method step:
different digital control commands are generated in a second generating method step, and/or
different digital control commands are transmitted in the transmitting method step.

15. The method according to claim 9, wherein in an activating method step, an activation of the furniture element, in particular a drive or an activation of at least one part of an item of furniture by the furniture element, is effected through at least one digital control command received, wherein an activation of the at least one furniture element with the control command wirelessly received by the receiving device of the at least one furniture element is effected by the control device within a period of less than 100 ms, preferably less than 50 ms, from the transmission of the digital control command.

16. The method according to claim 9, wherein the at least one control device has at least one user operating mode and one configuration operating mode, wherein:
in the user operating mode a reception of a digital operating command by the receiving device of the at least one control device for actuating at least one furniture element is effected, and/or
in the configuration operating mode a reception of a digital operating command by the receiving device of the at least one control device for configuring the control device is effected.

17. A computer program product, comprising commands from a memory unit which is in or can be brought into data connection with the processing unit that, when executed by a processing unit, cause the latter to perform the method according to claim 9.

18. A control device for a system according to claim 1.
